(19) United States
(12) Patent Application Publication
(10) Pub. No.: US 2003/0145311 A1
(43) Pub. Date: Jul. 31, 2003

(54) Generating simulation code

(76) Inventors: William R. Wheeler, Southborough, MA (US); Timothy J. Fennell, Holliston, MA (US)

Correspondence Address: FISH & RICHARDSON, PC, 4350 LA JOLLA VILLAGE DRIVE, SUITE 500, SAN DIEGO, CA, 92122, US

(21) Appl. No.: 10/057,193

(22) Filed: Jan. 25, 2002

(51) Int. Cl. G06F 9/44

(52) U.S. Cl. 717/135; 717/115

(57) ABSTRACT

A method of generating circuit simulation code using a computer language includes declaring a width of a state variable equal to a width of a vector state where the vector state has a width greater than a system platform width. The method also includes extracting data from the vector state and placing the data in the state variable.

### TECHNICAL FIELD

This invention relates to generating simulation code.

### BACKGROUND

Computer languages and their associated compilers have a predetermined state width, sometimes called a native platform word width. For example, the C++ computer language has a native platform word width of 32 bits. Typically, a state width that is larger than the native platform word width is represented by multiple values having a width equal to or smaller than the native platform word width. For example, in C++, a 96-bit state can be represented as three 32-bit values.

A simulator is used by a software developer to run and test software code. Typically, simulators run code that will be compiled by a compiler. Simulators use states to store information as the software code is processed.

### DESCRIPTION OF THE DRAWINGS

FIG. 1 is a flowchart of a process for generating simulation code.

FIG. 2 is a block diagram of a computer system on which the process of FIG. 1 may be implemented.

### DESCRIPTION

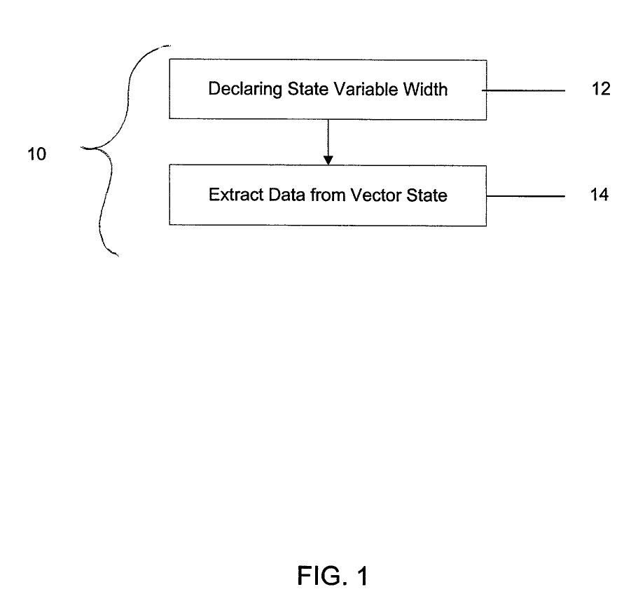

Referring to FIG. 1, process 10 generates simulation code for use with a computer language. In this embodiment, the simulation code may be used to simulate digital circuits; however, the invention is not limited as such.

Process 10 allows a simulator to have internal states that exceed a predetermined state width, called a native platform word width. In this regard, when designing a high performance processor, a user typically has to deal with large state widths, which often exceed the native platform word width. In a C++ simulator, these states should be defined and handled properly to avoid costly errors. For example, in most C++ simulators, the user is restricted to 32-bit data values. Thus, when comparing two 64-bit states, the simulator is required to compare a low word value (the first 32 bits) and high word value (the last 32 bits).

Process 10 allows for state variables larger than the native platform word width to be generated and used as though these state variables were within the native platform width. Process 10 declares (12) a width of a state variable to be equal to the size of the vector state width. The size of the state variable width is declared within the simulation code. The vector state is generated by the user through an input/output device (e.g., a console) by simply inputting the width size of the vector state. The width of the vector state is n bits wide, where n≧1. By generating the vector state, the data for the vector state can be retrieved in one process action from memory instead of multiple actions. Process 10 extracts (14) data from the vector state by going to memory and extracting the information in a single action. All n bits of the vector state are extracted from memory in one action and placed in the state variable.

At a simulation console (not shown), a user can dynamically create a simulation vector state by specifying a width of the vector state. The vector state can be compared or used in software expressions in what is referred to herein as “an atomic action.” An atomic action is an operation in which an entire vector state is used at a time (i.e., not in portions). That is, the vector state need not be split-up before processing. Generating vector states simplifies the writing of simulation scripts used to drive simulations, because it reduces the number of lines in the simulation code. For example, there is no longer a need to break-up the state and do multiple comparisons.

In more detail, absent process 10, the softwayre code to compare two 80-bit state variables, state1 and state2, is as follows:

| | |
|---|---|
| 1 | unsigned int[3]state1; //Declare states |
| 2 | unsigned int[3]state2; |
| 3 | unsigned int[2]carryout; |
| 4 | //Extract simulation state1 |
| 5 | state1[0]=simulator_vector_state1[31:0]; |
| 6 | state1[1]=simulator_vector_state1[63:32]; |
| 7 | state1[2]=simulator_vector_state1[79:64]&0xFFFF |
| 8 | //Extract simulation state 2 |
| 9 | state2[0]=simulator_vector_state2[31:0]; |
| 10 | state2[1]=simulator_vector_state2[63:32]; |
| 11 | state2[2]=simulator_vector_state2[79:64]&0xFFFF |
| 12 | //If state1 equals state2 increment state1 by 1 |
| 13 | if((state1[0]==state2[0]) && (state1[1]==state2[1]) && |

(state1[2]==state2[2]))

| | |
|---|---|
| 14 | { |
| 15 | carryout[0] = (state1[0]+1) ==0; //Are we going from |

0xffffffff to 0x00000000

| | |
|---|---|
| 16 | state1[0]=state1[0]+1; |
| 17 | carryout[1]=(state1[1]+carryout[0]) ==0 //Carry in |

the middle word

| | |
|---|---|
| 18 | state1[1]=state1[1]+carryout[0]); |
| 19 | state1[2]=(state1[2]+carryout[1]) & 0xFFFF; |
| 20 | } |

In lines 5-7 of the foregoing software code, state1 is extracted 32-bits at a time using three line of software code. This extraction process generates three values. These three values are stored in three separate data memory locations. Likewise, in lines 9-11, state2 is extracted 32-bits at a time. This extraction process also generates three values. The only way to determine if the two states, state1 and state2, are the same is to compare separately the values that make-up the two states. To make this comparison in the software code, the code must account for each of the values making-up the state.

By contrast, software code may be developed in accordance with process 10, which eliminates the need for three separate comparisons. One example of software code to implement process 10 to compare two state variables, state1 and state2, is as follows:

| | |
|---|---|
| 1 | vector80(state1); //declare states |
| 2 | vector80(state2); |
| 3 | //extract simulator state1 |
| 4 | state1(79,0)=simulator vector_state1 (79,0); |
| 5 | //extract simulator state2 |
| 6 | state2(79,0)=simulator_vector_state2 (79,0); |
| 7 | //if state1 equals state2 increment state1 by 1 |
| 8 | if(state1(79,0)==state2(79,0)) |

| | |
|---|---|
| 9 | { |
| 10 | state1 (79,0)=state1 (79,0)+1; |
| 11 | } |

Using process 10, state1 is extracted in one line (see line 4) and state2 is also extracted in one line(see line 6). Thus, when the two state variables are compared, the software code compares the entire state1 to the entire state2 in an atomic (i.e., single) action. Thus, there is no need for three separate comparisons.

By using vector states in simulation code generation, the user can code faster and make change easier. If the simulation platform changes, for example, the amount of platform specific input code changes is also reduced.

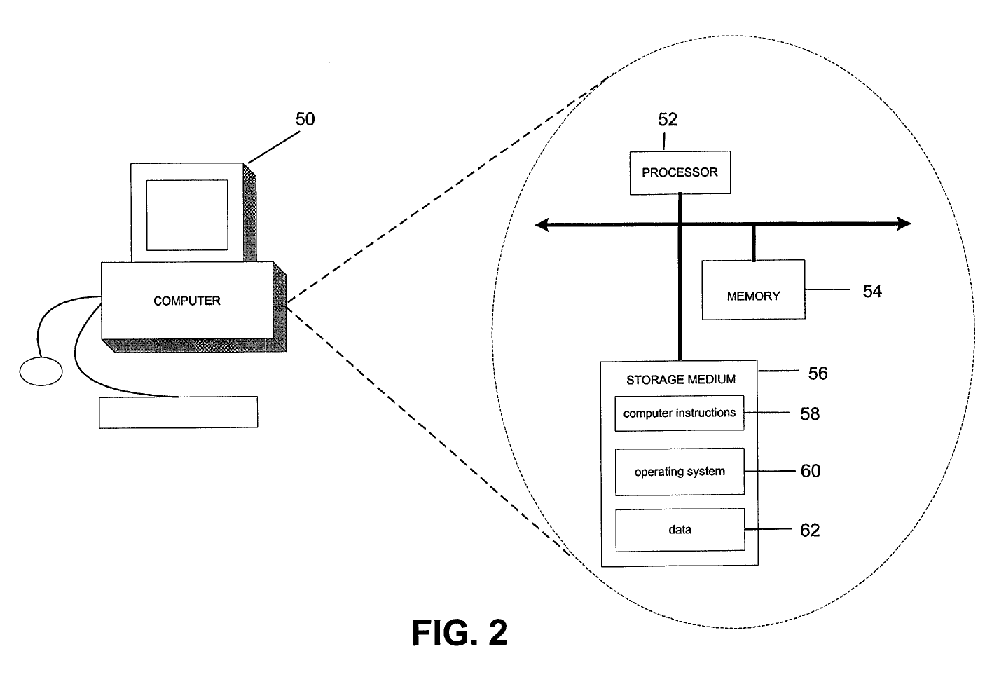

FIG. 2 shows a computer 50 for generating simulation code using process 10. Computer 50 includes a processor 52 for processing states, a memory 54, and a storage medium 56 (e.g., hard disk). Storage medium 56 stores operating system 60, data 62 for storing states, and computer instructions 58 which are executed by processor 52 out of memory 54 to perform process 10.

Process 10 is not limited to use with the hardware and software of FIG. 2; it may find applicability in any computing or processing environment and with any type of machine that is capable of running a computer program. Process 10 may be implemented in hardware, software, or a combination of the two. Process 10 may be implemented in computer programs executed on programmable computers/machines that each include a processor, a storage medium/article readable by the processor (including volatile and non-volatile memory and/or storage elements), at least one input device, and one or more output devices. Program code may be applied to data entered using an input device to perform process 10 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 10. Process 10 may also be implemented as a machine-readable storage medium, configured with a computer program, where upon execution, instructions in the computer program cause the computer to operate in accordance with process 10.

The invention is not limited to the specific embodiments described herein. For example, the generated vector state does not have to be processed by a simulator. The generated vector state can be used with any software or machine code that has a native platform width restriction. The invention is not limited to the specific processing order of FIG. 1. Rather, the blocks of FIG. 1 may be re-ordered, as necessary, to achieve the results set forth above.

Other embodiments not described herein are also within the scope of the following claims.

What is claimed is:

1. A method of generating circuit simulation code using a computer language, comprising:
declaring a width of a state variable equal to a width of a vector state, the vector state having a width greater than a system platform width; and
extracting data from the vector state and placing the data in the state variable.

2. The method of claim 1, further comprising generating the vector state using a simulator console.

3. The method of claim 2, wherein generating the vector state comprises specifying the width of the vector state.

4. The method of claim 1, further comprising displaying all n (n≧1) bits of the vector state, the width being n bits wide.

5. The method of claim 1, further comprising using the state variable in a single action.

6. The method of claim 5, wherein using the state variable in a single action comprises comparing the state variable to a second state variable.

7. The method of claim 1, further comprising generating a simulation script that includes the state variable, the simulation script for driving a simulation.

8. The method of claim 1, further comprising treating the vector state as a native simulator object, the native simulator object having a maximum state size allowable by a simulator in a single action.

9. The method of claim 1, wherein the data comprises n (n≧1) bits of a simulator state.

10. The method of claim 1, wherein extracting data from the vector state comprises extracting all n (n≧1) bits of the vector state, the width being n bits wide.

11. An apparatus comprising:
a memory that stores executable instructions for generating circuit simulation code using a computer language; and
a processor that executes the instructions to:
declare a width of a state variable equal to a width of a vector state, the vector state having a width greater than a system platform width; and
extract data from the vector state and placing the data in the state variable.

12. The apparatus of claim 11, further comprising instructions to generate the vector state using a simulator console.

13. The apparatus of claim 12, wherein to generate the vector state comprises specifying the width of the vector state.

14. The apparatus of claim 11, further comprising instructions to display all n (n≧1) bits of the vector state, the width being n bits wide.

15. The apparatus of claim 11, further comprising instructions to use the state variable in a single action.

16. The apparatus of claim 15, wherein to use the state variable in a single action comprises comparing the state variable to a second state variable.

17. The apparatus of claim 11, further comprising instructions to generate a simulation script that includes the state variable, the simulation script for driving a simulation.

18. The apparatus of claim 11, further comprising instructions to treat the vector state as a native simulator object, the native simulator object having a maximum width size allowable by a simulator in a signal action.

19. The apparatus of claim 11, wherein the data comprises n (n≧1) bits of a simulator state.

20. The method of claim 11, wherein to extract the data from the vector state comprises extracting all n (n≧1) bits of the vector state, the width being n bits wide.

21. An article comprising a machine-readable medium that stores executable instructions for generating circuit simulation code using a computer language, the instructions causing a machine to:
declare a width of a state variable equal to a width of a vector state, the vector state having a width greater than a system platform width; and
extract data from the vector state and placing the data in the state variable.

22. The article of claim 21, further comprising instructions causing the machine to generate the vector state using a simulator console.

23. The article of claim 22, wherein to generate the vector state comprises specifying the width of the vector state.

24. The article of claim 21, further comprising instructions causing the machine to display all n (n≧1) bits of the vector state, the width being n bits wide.

25. The article of claim 21, further comprising instructions causing the machine to use the state variable in a single action.

26. The article of claim 25, wherein to use the state variable in a single action comprises comparing the state variable to a second state variable.

27. The article of claim 21, further comprising instructions causing the machine to generate a simulation script that includes the state variable, the simulation script for driving a simulation.

28. The article of claim 21, further comprising instructions causing the machine to treat the vector state as a native simulator object, the native simulator object having a maximum width size allowable by a simulator in a signal action.

29. The article of claim 21, wherein the data comprises n (n≧1) bits of a simulator state.

30. The article of claim 21, wherein to extract the data from the vector state comprises extracting all n (n≧1) bits of the vector state, the width being n bits wide.

31. A computer instruction that generates a vector state, the vector state having a width larger than a predefined state width.

32. The computer instruction of claim 31, wherein the vector state is generated using a simulator console.

33. The computer instruction of claim 31, wherein the vector state is used to generate state variables.
